(19) United States
(12) Patent Application Publication
(10) Pub. No.: US 2026/0128484 A1
(43) Pub. Date: May 7, 2026

(54) BATTERY MODULE

(71) Applicant: TOYOTA JIDOSHA KABUSHIKI KAISHA, Toyota-shi (JP)

(72) Inventor: Nobuo MATSUI, Seto-shi (JP)

(73) Assignee: TOYOTA JIDOSHA KABUSHIKI KAISHA, Toyota-shi (JP)

(21) Appl. No.: 19/327,495

(22) Filed: Sep. 12, 2025

(30) Foreign Application Priority Data
Nov. 6, 2024 (JP) 2024-194450

(51) Int. Cl. H01M 50/586; H01M 50/414; H01M 50/489

(52) U.S. Cl. CPC H01M 50/586; H01M 50/414; H01M 50/489; H01M 2200/10

(57) ABSTRACT

A battery module includes a battery element, a first current collector electrically connected to the battery element, a second current collector disposed facing the first current collector and electrically connected to the first current collector, and a plurality of resin insulators disposed therebetween, in which the battery element includes a cathode, an anode, and a resin separator disposed between the cathode and the anode, the first and second current collectors are electrically insulated by the insulators in a portion at which the insulators are disposed therebetween, and are electrically connected to each other in a portion at which the insulators are not disposed therebetween, a melting point of the resin of the insulators is lower than a melting point of the resin of the separator, and the insulators melt and spread between the first and second current collectors as a result of generating heat due to passage of electricity therebetween.

### CROSS-REFERENCE TO RELATED APPLICATION

This application claims priority to Japanese Patent Application No. 2024-194450 filed on November 6, 2024. The disclosure of the above-identified application, including the specification, drawings, and claims, is incorporated by reference herein in its entirety.

### BACKGROUND

### 1. Technical Field

The technology disclosed in the present specification relates to a battery module.

### 2. Description of Related Art

A battery module is disclosed in Japanese Unexamined Patent Application Publication No. 2007-66806 (JP 2007-66806 A). The battery module according to JP 2007-66806 A includes a first current collector, a second current collector that is electrically connected to the first current collector, a plurality of insulators disposed between the first current collector and the second current collector, and a battery element that is electrically connected to the first current collector. The first current collector and the second current collector are electrically insulated by the insulators at portions at which the insulators are disposed therebetween, and are electrically connected at portions at which no insulator is disposed therebetween.

### SUMMARY

In a battery module, an excessive current may flow due to, for example, external short-circuiting or the like. This may cause the battery module to become abnormally hot, which can conceivably result in damage to the battery element, or the like. Accordingly, the present specification provides technology that enables abnormal temperature rising to be suppressed in a battery module.

According to a first aspect of the present technology, a battery module includes a battery element, a first current collector that is electrically connected to the battery element, a second current collector that is disposed facing the first current collector and that is electrically connected to the first current collector, and a plurality of insulators made of resin that are disposed between the first current collector and the second current collector. The battery element includes a cathode, an anode, and a separator that is made of resin, and that is disposed between the cathode and the anode. The first current collector and the second current collector are electrically insulated by the insulators in a portion at which the insulators are disposed between the first current collector and the second current collector, and are electrically connected to each other in a portion at which the insulators are not disposed between the first current collector and the second current collector. A melting point of the resin of the insulators is lower than a melting point of the resin of the separator. The insulators melt and spread between the first current collector and the second current collector as a result of the first current collector and the second current collector generating heat due to passage of electricity.

According to this configuration, when an excessive current flows through the battery module, causing the first current collector and the second current collector to generate abnormal heat, the insulators melt and spread between the first current collector and the second current collector. This enables passage of electricity between the first current collector and the second current collector to be interrupted or suppressed. As a result, excessive current can be suppressed from flowing through the battery module, and accordingly abnormal temperature rise in the battery module can be suppressed. Also, the insulators melt before the separator melts, and accordingly the battery element can be protected.

With a second aspect, in the above first aspect, a thickness of the insulators may be less than a thickness of the first current collector, and also may be less than a thickness of the second current collector.

With a third aspect, in the first or second aspect, the insulators may be arrayed in a first direction, and extend in a second direction that is different from the first direction.

With a fourth aspect, in the third aspect, a width of each of the insulators in the first direction may be narrower than a width between the insulators that are adjacent to each other in the first direction.

With a fifth aspect according to any one of the first to fourth aspects, a melting point of the resin of the insulators may be higher than an upper limit value of temperature during normal use of the battery module.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a battery module according to an embodiment;

FIG. 2 is a cross-sectional view taken along line II-II in FIG. 1; and

FIG. 3 is a diagram schematically illustrating the battery module according to the embodiment.

### DETAILED DESCRIPTION OF EMBODIMENTS

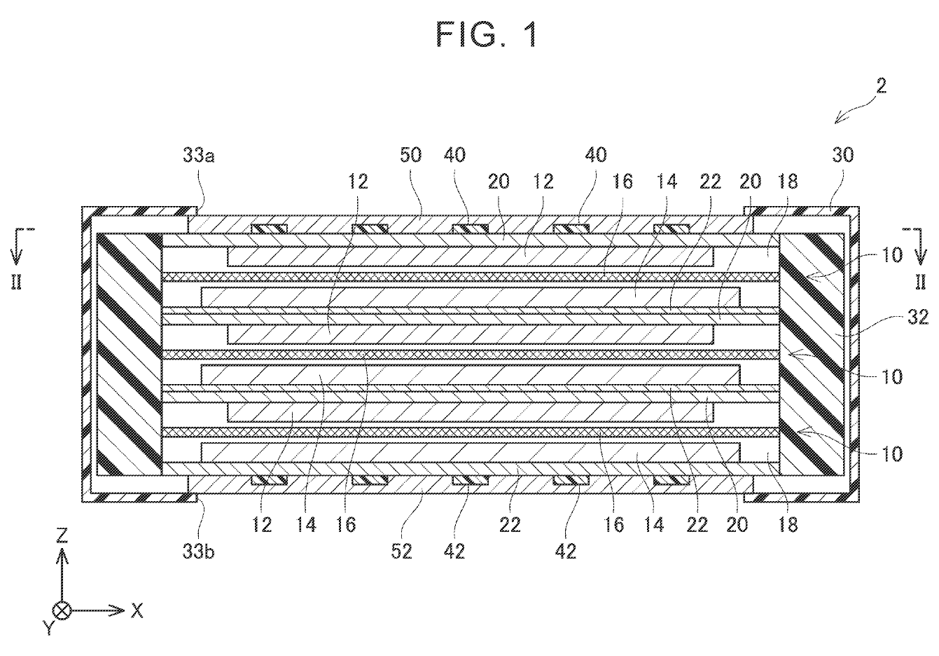

A battery module 2 according to an embodiment will be described with reference to the drawings. As illustrated in FIG. 1, the battery module 2 according to the embodiment includes a plurality of battery elements 10 and an outer encasement 30 that houses the battery elements 10. Also, the battery module 2 includes, in each of the battery elements 10, the cathode first current collector 20 and the anode first current collector 22 that collect electricity that is generated by the battery element 10. The battery module 2 also includes a cathode second current collector 50 and an anode second current collector 52 that collect electricity that is generated by the battery elements 10. Further, the battery module 2 includes a plurality of cathode insulators 40 disposed between the cathode first current collector 20 and the cathode second current collector 50, and a plurality of anode insulators 42 disposed between the anode first current collector 22 and the anode second current collector 52.

The battery elements 10 are disposed in a stacked manner inside the outer encasement 30, and are electrically connected in series. Each of the battery elements 10 makes up, for example, a lithium-ion battery. Each of the battery elements 10 includes a cathode 12, an anode 14, and a separator 16 that is disposed between the cathode 12 and the anode 14. Each of the battery elements 10 also contains an electrolytic solution 18.

The battery elements 10 are disposed such that, between battery elements 10 that are adjacent to each other, the cathode 12 of one battery element 10 and the anode 14 of the other battery element 10 face each other. The battery elements 10 are disposed such that the cathodes 12 of each thereof face one side (upward in FIG. 1) and the anodes 14 of each thereof face the other side (downward in FIG. 1).

The cathode 12 of the battery element 10 is provided on a surface of the cathode first current collector 20. The surface of the cathode first current collector 20 is coated with the cathode 12. The cathode 12 is produced, for example, by applying a paste containing a cathode active material onto the surface of the cathode first current collector 20 and then performing drying thereof. The cathode active material that is the material of the cathode 12 is, for example, lithium cobalt oxide (LiCoO₂), lithium manganese oxide (LiMn₂O₄), lithium nickel oxide (LiNiO₂), or the like, but is not limited in particular. A method for producing the cathode 12 is not limited in particular, either.

The anode 14 of the battery element 10 is provided on the surface of the anode first current collector 22. The surface of the anode first current collector 22 is coated with the anode 14. The anode 14 is produced, for example, by applying a paste containing an anode active material onto the surface of the anode first current collector 22 and then performing drying thereof. The anode active material, which is the material of the anode 14, is graphite, hard carbon, soft carbon, or the like, for example, but is not limited in particular. A method for producing the anode 14 is not limited in particular, either.

The separator 16 is made of a resin having ion conductivity, and is in the form of a film. The separator 16 is made of, for example, polypropylene (PP), polyethylene (PE), or a combination thereof. The separator 16 has a thickness of, for example, 20 μm. A peripheral edge of the separator 16 is fixed to a support member 32 that is disposed inside the outer encasement 30.

Between the cathode 12 and the separator 16 of the battery element 10, and between the anode 14 and the separator 16, is filled with the electrolytic solution 18. The electrolytic solution 18 is a liquid that contains an electrolyte. The electrolyte is, for example, a lithium salt such as LiPF₆, LiClO₄, LiBF₄, or the like, but is not limited in particular.

The cathode first current collector 20 is made of a metal having electrical conductivity. The cathode first current collector 20 is made of a metal containing aluminum (Al) in a form of foil, for example. The thickness of the cathode first current collector 20 is, for example, 100 μm or less. The cathode first current collector 20 is electrically connected to the battery element 10, and collects electricity generated by the battery element 10. The cathode first current collector 20 is electrically connected to the cathode 12 of the battery element 10 and collects electricity from the cathode 12. A peripheral edge of the cathode first current collector 20 is fixed to a support member 32 that is disposed inside the outer encasement 30.

The anode first current collector 22 is made of a metal having electrical conductivity. The anode first current collector 22 is made of a metal containing copper (Cu) in a form of foil, for example. The thickness of the anode first current collector 22 is, for example, 100 μm or less. The anode first current collector 22 is electrically connected to the battery element 10, and collects electricity that is generated by the battery element 10. The anode first current collector 22 is electrically connected to the anode 14 of the battery element 10 and collects electricity from the anode 14. A peripheral edge of the anode first current collector 22 is fixed to the support member 32 that is disposed inside the outer encasement 30.

Of a plurality of the cathode first current collectors 20 and a plurality of the anode first current collectors 22, one cathode first current collector 20 and one anode first current collector 22 that face each other are integrated by being applied to each other. The cathode first current collector 20 and the anode first current collector 22 that face each other are electrically connected. The cathode first current collector 20 and the anode first current collector 22 that face each other may be produced integrally in advance.

The cathode second current collector 50 is made of a metal having electrical conductivity. The cathode second current collector 50 is made of a metal containing aluminum (Al) in a form of foil, for example. The thickness of the cathode second current collector 50 is, for example, 100 μm or less. The cathode second current collector 50 is electrically connected to the battery element 10 via the cathode first current collector 20, and collects electricity that is generated by the battery element 10. The cathode second current collector 50 is electrically connected to the cathode first current collector 20 that is situated on the outermost side (the upper side in FIG. 1) among the cathode first current collectors 20, and collects electricity from this cathode first current collector 20. A peripheral edge of the cathode second current collector 50 is fixed to the outer encasement 30.

The anode second current collector 52 is made of a metal having electrical conductivity. The anode second current collector 52 is made of a metal containing copper (Cu) in a form of foil, for example. The thickness of the anode second current collector 52 is, for example, 100 μm or less. The anode second current collector 52 is electrically connected to the battery element 10 via the anode first current collector 22, and collects electricity that is generated by the battery element 10. The anode second current collector 52 is electrically connected to the anode first current collector 22 that is situated on the outermost side (lower side in FIG. 1) among the anode first current collectors 22, and collects electricity from this anode first current collector 22. A peripheral edge of the anode second current collector 52 is fixed to the outer encasement 30.

The support member 32 that is disposed inside the outer encasement 30 supports the cathode first current collector 20, the anode first current collector 22, and the separator 16. The support member 32 seals a portion of the battery element 10 that is filled with the electrolytic solution 18. That is to say, the support member 32 seals between the cathode first current collector 20 and the separator 16, and between the anode first current collector 22 and the separator 16. The support member 32 is made of an insulating resin. The support member 32 is made of, for example, polypropylene (PP), polyethylene (PE), or a combination thereof.

The outer encasement 30 houses the battery element 10 and the support member 32 that supports the battery element 10. The outer encasement 30 surrounds the battery element 10 and the support member 32. The outer encasement 30 is made of an insulating resin. The outer encasement 30 is made of, for example, polypropylene (PP), polyethylene (PE), or a combination thereof.

The outer encasement 30 includes a cathode side opening 33a that opens on a cathode side of the battery element 10, and an anode side opening 33b that opens on an anode side of the battery element 10. The cathode second current collector 50 is disposed in the cathode side opening 33a. The cathode second current collector 50 closes off the cathode side opening 33a. The peripheral edge of the cathode second current collector 50 is fixed to the outer encasement 30. Similarly, the anode second current collector 52 is disposed in the anode side opening 33b. The anode second current collector 52 closes the anode side opening 33b. The peripheral edge portion of the anode second current collector 52 is fixed to the outer encasement 30.

Next, the cathode insulators 40 that are disposed between the cathode first current collector 20 and the cathode second current collector 50 will be described. The cathode insulators 40 are provided along the surface of the cathode first current collector 20 (upper face in FIG. 1) and also along a surface of the cathode second current collector 50 (lower face in FIG. 1).

The cathode first current collector 20 and the cathode second current collector 50 are in close contact with each other, in a state in which the cathode insulators 40 are interposed therebetween. The cathode first current collector 20 and the cathode second current collector 50 are brought into close contact with each other across the cathode insulators 40, when the outer encasement 30 is molded by vacuum molding. The cathode first current collector 20 and the cathode second current collector 50 are separated from each other by the cathode insulators 40 at the portions at which the cathode insulators 40 are disposed therebetween, and are in contact with each other at the portions at which the cathode insulators 40 are not disposed. The cathode first current collector 20 and the cathode second current collector 50 are electrically insulated by the cathode insulators 40 at the portions at which the cathode insulators 40 are disposed therebetween, and are electrically connected at the portions at which the cathode insulators 40 are not disposed.

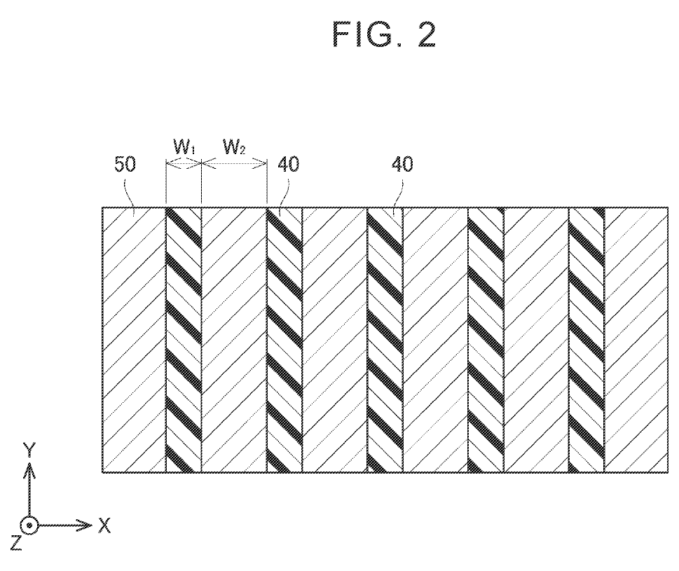

As illustrated in FIG. 2, the cathode insulators 40 are disposed arrayed in a striped pattern. The cathode insulators 40 are disposed at intervals in a first direction (X direction in FIG. 2). Each of the cathode insulators 40 extends in a second direction (Y direction in FIG. 2) that is perpendicular to the first direction. A width W1 in the first direction of each of the cathode insulators 40 is narrower than a width W2 between one cathode insulator 40 and another cathode insulator 40 that are adjacent to each other in the first direction. For example, W1 ≤ 0.3 W2.

Each of the cathode insulators 40 is formed in a form of a film. The cathode insulators 40 have a thickness of 20 μm., for example. The thickness of the cathode insulators 40 is thinner than the thickness of the cathode first current collector 20, and is also thinner than the thickness of the cathode second current collector 50. The thickness of the cathode insulators 40 is, for example, 20% or less of the thickness of the cathode first current collector 20. The thickness of the cathode insulators 40 is, for example, 20% or less of the thickness of the cathode second current collector 50.

Each of the cathode insulators 40 is made of resin. The cathode insulators 40 are made of, for example, low density polyethylene (PE), high density polyethylene (PE), polypropylene (PP), or a combination of several of these resins. The melting point of low density polyethylene (PE) is approximately 100°C to 115°C. The melting point of high density polyethylene (PE) is approximately 125°C to 140°C. The melting point of polypropylene (PP) is approximately 160°C. The melting point of the resin of the cathode insulators 40 is lower than the melting point of the resin of the separator 16 of the battery element 10. The melting point of the resin of the cathode insulators 40 is, for example, a temperature that is 20°C or more lower than the melting point of the resin of the separator 16 of the battery element 10.

Also, the melting point of the resin of the cathode insulators 40 may be, for example, a temperature that is higher than an upper limit value of the temperature during normal use of the battery module 2. For example, the melting point of the resin of the cathode insulators 40 is a temperature that is higher than the upper limit value of the temperature during normal use of the battery module 2 by a temperature of 20°C or more. The temperature during normal use of the battery module 2 may be, for example, a temperature that is managed by a cooling system (omitted from illustration) of the battery module 2, taking into consideration the lifespan and safety of the battery module 2. The upper limit value of the temperature during normal use of the battery module 2 is, for example, 70°C.

Also, the melting point of the resin of the cathode insulators 40 may be, for example, a temperature that is lower than an overheating mode threshold temperature. For example, the melting point of the resin of the cathode insulators 40 is lower than the overheating mode threshold temperature by a temperature of 40°C or more. The overheating mode threshold temperature may be set to, for example, the same temperature as the melting point of the resin of the separator 16 of the battery element 10.

The configuration of the anode insulators 42 that are disposed between the anode first current collector 22 and the anode second current collector 52 is the same as the configuration of the cathode insulators 40 that are disposed between the cathode first current collector 20 and the cathode second current collector 50, and accordingly detailed description will be omitted. The configuration of the anode insulators 42 is described by replacing "cathode" of the cathode insulators 40 above with "anode".

In the above-described battery module 2, when the battery elements 10 generate electricity, and a current flows through the cathode first current collector 20 and the cathode second current collector 50, the cathode first current collector 20 and the cathode second current collector 50 generate heat due to the passage of electricity. In the battery module 2, when the cathode first current collector 20 and the cathode second current collector 50 generate heat, the temperature of the cathode insulators 40 that are disposed between the cathode first current collector 20 and the cathode second current collector 50 rises. The cathode insulators 40 melt when the temperature thereof reaches or exceeds the melting point thereof.

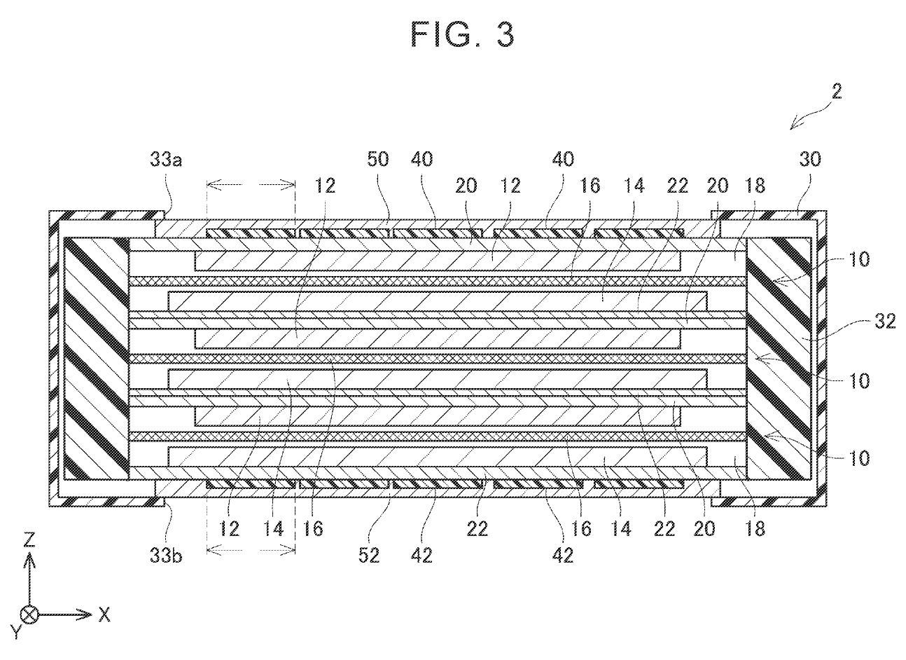

As illustrated in FIG. 3, the cathode insulators 40 that are disposed between the cathode first current collector 20 and the cathode second current collector 50 melt, and thus spread laterally between the cathode first current collector 20 and the cathode second current collector 50. This increases the area that is insulated between the cathode first current collector 20 and the cathode second current collector 50 by the cathode insulators 40. Accordingly, resistance between the cathode first current collector 20 and the cathode second current collector 50 increases. As a result, the current flowing over the cathode first current collector 20 and the cathode second current collector 50 is attenuated, or the current is interrupted.

While the cathode side of the battery module 2 has been described in the above description, the same is true for the anode side as the cathode side. The anode side is described by replacing "cathode" in the above description with "anode".

### Effects

The battery module 2 according to the embodiment has been described above. It is clear from the above explanation that the battery module 2 includes the cathode first current collector 20 that is electrically connected to the battery element 10, and the cathode second current collector 50 that is disposed facing the cathode first current collector 20 and that is electrically connected to the cathode first current collector 20. The battery module 2 also includes the cathode insulators 40 that are made of resin and that are disposed between the cathode first current collector 20 and the cathode second current collector 50. The battery element 10 includes the cathode 12, the anode 14, and the separator 16 that is made of resin and that is disposed between the cathode 12 and the anode 14. The melting point of the resin of the cathode insulators 40 is lower than the melting point of the resin of the separator 16. The cathode insulators 40 melt and spread between the cathode first current collector 20 and the cathode second current collector 50, as a result of heat generation due to passage of electricity between the cathode first current collector 20 and the cathode second current collector 50.

According to this configuration, when an excessive current flows through the battery module 2 and causes the cathode first current collector 20 and the cathode second current collector 50 to abnormally heat up, the cathode insulators 40 melt and spread between the cathode first current collector 20 and the cathode second current collector 50. This enables passage of electricity between the cathode first current collector 20 and the cathode second current collector 50 to be interrupted or suppressed. As a result, excessive current can be suppressed from flowing through the battery module 2, and accordingly abnormal temperature rise in the battery module 2 can be suppressed. Furthermore, the cathode insulators 40 melt before the separator 16 melts, whereby the battery element 10 can be protected.

The thickness of the cathode insulators 40 is thinner than the thickness of the cathode first current collector 20, and is also thinner than the thickness of the cathode second current collector 50. According to this configuration, the cathode first current collector 20 and the cathode second current collector 50 can be in suitable contact with each other under normal circumstances. Also, the overall thickness of the battery module 2 can be reduced.

The cathode insulators 40 are arrayed in the first direction (X direction in FIG. 2 ) and extend in the second direction (Y direction in FIG. 2 ) that is different from the first direction. According to this configuration, the cathode insulators 40 can be easily formed.

The width W1 in the first direction of each of the cathode insulators 40 is narrower than the width W2 between one cathode insulator 40 and another cathode insulator 40 that are adjacent to each other in the first direction. According to this configuration, the cathode first current collector 20 and the cathode second current collector 50 can be in suitable contact with each other under normal circumstances.

Note that while the cathode side of the battery module 2 has been described in the above description, the same is true for the anode side as the cathode side. The anode side is described by replacing "cathode" in the above description with "anode".

### Modifications

(1) In the above embodiment, the cathode insulators 40 are disposed in stripes, but the layout is not limited in particular. It is sufficient for the cathode insulators 40 to be disposed at intervals. The same is true for the anode insulators 42.

(2) In the above embodiment, the direction in which the cathode insulators 40 are arrayed (first direction) and the direction in which the cathode insulators 40 extend (second direction) are orthogonal to each other, but this configuration is not limiting. The first direction and the second direction do not have to be orthogonal to each other.

(3) The difference between the melting point of the resin of the cathode insulators 40 and the melting point of the separator 16 of the battery element 10 may be greater than the difference between the melting point of the resin of the cathode insulators 40 and the upper limit value of the temperature during normal use of the battery module 2. According to this configuration, abnormal temperature rise in the battery module 2 can be further suppressed.

Although specific examples of the present disclosure have been described in detail above, these are only exemplary, and do not limit the scope of the claims. The technology that is described in the claims includes various modifications and variations of the specific example that is exemplified above. Also, the technical elements that are described in the present specification and the drawings exhibit technical utility either alone or in various combinations, and are not limited to the combinations described in the claims at the time of filing. Also, the technology exemplified in the present specification or drawings can achieve multiple objectives simultaneously, and achieving any one of these objectives has in itself technical utility.

What is claimed is:

1. A battery module comprising:
a battery element;
a first current collector that is electrically connected to the battery element;
a second current collector that is disposed facing the first current collector and that is electrically connected to the first current collector; and
a plurality of insulators made of resin that are disposed between the first current collector and the second current collector, wherein
the battery element includes a cathode, an anode, and a separator that is made of resin, and that is disposed between the cathode and the anode,
the first current collector and the second current collector are electrically insulated by the insulators in a portion at which the insulators are disposed between the first current collector and the second current collector, and are electrically connected to each other in a portion at which the insulators are not disposed between the first current collector and the second current collector,
a melting point of the resin of the insulators is lower than a melting point of the resin of the separator, and
the insulators melt and spread between the first current collector and the second current collector as a result of the first current collector and the second current collector generating heat due to passage of electricity.

2. The battery module according to claim 1, wherein a thickness of the insulators is less than a thickness of the first current collector, and also less than a thickness of the second current collector.

3. The battery module according to claim 1, wherein the insulators are arrayed in a first direction, and extend in a second direction that is different from the first direction.

4. The battery module according to claim 3, wherein a width of each of the insulators in the first direction is narrower than a width between the insulators that are adjacent to each other in the first direction.

5. The battery module according to claim 1, wherein a melting point of the resin of the insulators is higher than an upper limit value of temperature during normal use of the battery module.
